(19) United States
(12) Patent Application Publication
(10) Pub. No.: US 2001/0011243 A1
(43) Pub. Date: Aug. 2, 2001

(54) Risk management system, distributed framework and method

(76) Inventors: Ron Dembo, Toronto (CA); Alon Adar, Toronto (CA); Neil Edward Bartlett, Toronto (CA); Brian Parkinson, Toronto (CA); David Perry, Toronto (CA); Michael Zerbs, Markham (CA)

Correspondence Address: PATENT ADMINSTRATOR, KATTEN MUCHIN ZAVIS, SUITE 1600, 525 WEST MONROE STREET, CHICAGO, IL, 60661, US

(21) Appl. No.: 09/811,684

(22) Filed: Mar. 20, 2001

Related U.S. Application Data
(63) Continuation of application No. 09/323,680, filed on Jun. 2, 1999.

(51) Int. Cl. G06F 17/60

(52) U.S. Cl. 705/36

(57) ABSTRACT

A risk management system and method of determining a risk metric for a portfolio of instruments is provided. The system and method include a database wherein determined risk values for instruments in a set of instruments under each scenario can be maintained. At least one risk engine can be employed to determine values for the instruments and at least one aggregation engine can be employed to produce desired risk metrics for the set of instruments or a subset thereof. Each risk engine and each aggregation engine is connected to the database by an appropriate network.

### FIELD OF THE INVENTION

The present invention relates to risk management systems. More specifically, the present invention relates to a risk management system, a distributed framework therefore and a method of determining at least one risk metric for a portfolio or portfolios of instruments.

### BACKGROUND OF THE INVENTION

Risk Management systems are known and are commonly employed by financial institutions, resource-based corporations, trading organizations, governments or other users to make informed decisions to assess and/or manage the risk associated with the operations of the user.

One popular example of a known risk management system is the RiskWatch V3.1.2 system, sold by the assignee of the present invention. This system is very flexible and allows users to employ models of the instruments in the user's portfolio, which models are evaluated at appropriate time intervals, in view of a range of possible scenarios. Each scenario comprises a set of values for the risk factors employed in the models, at each time interval, and each scenario has an assigned probability. The resulting risk values of the instruments when evaluated under each scenario at each time interval of interest are then used to produce one or more risk metrics which are examined to assess the risk to the user of holding the portfolio of instruments under the evaluated scenarios. Perhaps the most common risk value is the monetary value of the instrument or instruments under consideration, although other risk values including deltas, gammas and other computed values can also be employed. By combining these risk values appropriately, desired risk metrics can be obtained so that the user can identify opportunities for changing the composition of the portfolio to reduce the overall risk or to achieve an acceptable level of risk. The general principles of such risk management systems are described in further detail below.

Known risk management systems do however suffer from some problems. Generally, those most interested in employing risk management systems are users with complex and/or large portfolios of instruments. In such cases, the complexity and/or size of these portfolios result in the requirement for a great number of complex mathematical calculations to be performed to produce the risk values and risk metrics required by the user. One problem which results from this is that, for a significant portfolio, running the risk analysis operation can require hours, or tens of hours, even when run on high performance computing equipment. Thus, risk management analysis is often performed overnight and is always out of date, to some extent, as it is a snapshot of what the risk was the proceeding day (or whenever the analysis was run). In time critical environments, such as financial trading operations, this can be a significant disadvantage.

Another problem which exists is that, due to the time required to perform the risk analysis, the ability to determine sensitivities of a portfolio to various risk factors is constrained. Specifically, due to the complexity of the interactions between instruments in the portfolio, it is seldom possible to predict with high certainty the risk factors that have the largest effects on the overall risk. Yet, if the risk factors to which the portfolio is most sensitive can be identified, then remedial actions can be taken to reduce the risk, etc. and this represents much of the potential benefit of risk management. The identification of risk factor sensitivities in a portfolio generally requires that a risk analysis be re-run with various risk factors “flattened out” or held constant in the scenarios, in an attempt to determine the sensitivity of the portfolio to particular risk factors. Unfortunately, due to the time required to run the risk analysis, the amount of sensitivity analysis that can be performed in this manner is usually less than is desired.

Also, for similar reasons, the amount of “what-if” analysis that can be run is also limited and thus a user may have less information than desired about the consequences of possible or desired changes to their portfolio.

Another problem with known risk management systems is that they are monolithic systems. Specifically, a portfolio is modeled and processed to produce the risk metrics. If a subset of the portfolio is desired to be analyzed, the risk analysis must be re-run on the instruments in that subset. Similarly, if it is desired to combine a portfolio with one or more other portfolios, the entire analysis must be re-run on the combined portfolio. This inhibits effective risk management on an enterprise-wide basis for many users, as responsibility and management of portfolios are often distributed through the enterprise. Thus, while local offices and/or particular management functions can regularly run a risk analysis on their portfolios, the enterprise cannot combine the resulting analysis from each office/function into a single risk analysis for the enterprise's overall portfolio. At best, a new analysis must be run on the overall portfolio which can require significant time and effort.

A particular disadvantage of such monolithic system is that they are very inefficient at determining marginal risk metrics. For example with conventional risk management systems, analyzing the change in risk that a proposed transaction can make requires calculating the risk for the portfolio without the transaction and recalculating the risk for portfolio with the transaction to determine the difference. This is further exacerbated when considering risk at various levels of an enterprise. Specifically, assuming an enterprise has one or more local offices which report to a regional office and the enterprise has one or more of such regional offices. A local office will calculate the risk for its portfolio with and without the proposed transaction to determine the marginal risk of the transaction at the local office level. If the marginal risk is acceptable at the local office level, the regional office will calculate the risk for the regional portfolio, including the local portfolio, with and without the proposed transaction to determine the marginal risk of the transaction at the regional office level. If the marginal risk is acceptable at the regional office level, the enterprise will calculate the risk for the enterprise portfolio, including the regional and local portfolios, with and without the proposed transaction to determine the marginal risk of the transaction at the enterprise level. When another potential transaction is to be considered, the entire process must be repeated. As will be apparent to those of skill in the art, the analysis of marginal risk metrics quickly becomes too computationally expensive and is generally only employed on a very limited basis.

It is therefore desired to have a risk management system and method for determining risk metrics such that sensitivity, “what-if” and marginal analyses can be performed efficiently and such that risk analysis on portfolios and sub-portfolios, for example at the enterprise and lower levels, can be effectively performed.

### SUMMARY OF THE INVENTION

It is an object of the present invention to provide a novel risk management system and method which obviates or mitigates at least one of the above-mentioned disadvantages of the prior art.

According to a first aspect of the present invention, there is provided a method of determining at least one risk metric for a portfolio of instruments, comprising the steps of:

(i) selecting a set of instruments, each instrument in said set having a model defined therefore, each model operating on at least one risk factor to produce a value for said instrument;

(ii) selecting a set of scenarios, each scenario comprising a risk factor value for each risk factor operated on by said models of said instruments at at least a first and second time interval and each scenario having a probability value assigned thereto, said probability value representing the likelihood of said scenario occurring;

(iii) applying said selected set of scenarios to said set of instruments to produce a risk value for each instrument in said set of instruments for each scenario in said set of scenarios for each time interval;

(iv) storing in a database each instrument risk value produced for each instrument in said set; and

(v) for a portfolio of instruments comprising at least a subset of said set of instruments, producing a desired risk metric from said associated probabilities and said determined risk values for each instrument of said portfolio by retrieving said stored risk values from said database.

According to another aspect of the present invention, there is provided a risk management system operable on set of instruments and a set of scenarios, each scenario including risk factor values and a scenario probability, said system comprising:

at least one risk engine operable to determine a risk value for each instrument in said set of instruments, said risk value determined by evaluating, in view of said risk factors in said scenario, a model stored for said instrument;

a database to store each said determined risk value; and

an aggregating engine to retrieve said determined risk values and said scenario probabilities for a portfolio comprising at least a subset of said set of instruments to produce a risk metric.

According to yet another aspect of the present invention, there is provided a method of determining the marginal risk in at least one risk metric for a portfolio, comprising a set of instruments, which would result from a proposed transaction to alter said portfolio, each instrument in said portfolio and each instrument in said proposed transaction having a model defined therefore, each model operating on at least one risk factor to produce a value for said instrument, the method comprising the steps of:

(i) selecting a set of scenarios, each scenario comprising a risk factor value for each risk factor operated on by said models of said instruments at at least a first and second time interval and each scenario having a probability value assigned thereto, said probability value representing the likelihood of said scenario occurring;

(ii) applying said selected set of scenarios to said portfolio to produce a first risk value for each instrument in said portfolio for each scenario in said set of scenarios for each time interval;

(iii) storing in a database each first risk value produced for each instrument in said portfolio;

(iv) producing a first measure of said at least one risk metric from said associated probabilities and said determined first risk values for each instrument of said portfolio by retrieving said stored first risk values from said database;

(v) for each instrument in said set of instruments affected by said proposed transaction, altering each said affected instrument in accordance with said propose transaction and applying said selected set of scenarios to each altered instrument to produce a second risk value for each altered instrument for each scenario in said set of scenarios for each time interval; and

(vi) producing a second measure of said at least one risk metric by combining associated probabilities and said second risk values for said altered instruments with said first stored risk values for unaltered instruments in said set of instruments retrieved from said database to produce a second measure of said at least one risk metric.

According to yet another aspect of the present invention, there is provided a method of determining counter party credit exposure risk for a portfolio comprising a set of instruments, comprising the steps of:

(i) selecting a set of scenarios, each scenario comprising a risk factor value for each risk factor operated on by said models of said instruments at at least a first and second time interval and each scenario having a probability value assigned thereto, said probability value representing the likelihood of said scenario occurring;

(ii) applying said selected set of scenarios to said portfolio to produce a value for each instrument in said portfolio for each scenario in said set of scenarios for each time interval;

(iii) storing in a database each value produced for each instrument in said portfolio; and

(iv) determining a subset of said set of instruments for which a first party of interest is the counter party and determining the credit exposure for said first party of interest by retrieving said stored values and said associated probabilities from said database.

The present invention provides a risk system and method of determining risk which allows risk calculations to be performed in parallel, allows multiple risk engines and/or aggregation engines to simultaneously operate on risk data and allows what-if and other analysis to be quickly and efficiently performed. Portfolio make up can be changed and risk metrics determined in an iterative fashion, if desired.

### BRIEF DESCRIPTION OF THE DRAWINGS

Preferred embodiments of the present invention will now be described, by way of example only, with reference to the attached Figures, wherein:

FIG. 1 shows a schematic representation of a prior art mark to market valuation function of an instrument;

FIG. 2 shows a schematic representation of a prior art mark to fixture valuation function of an instrument for a single scenario;

FIG. 3 shows a flowchart of a prior art method of determining a risk metric in the form of a distribution of portfolio values and probabilities;

FIG. 4 shows a value versus probability distribution produced by the method of FIG. 3;

FIG. 5 shows a block diagram of an embodiment of the present invention;

FIG. 6 shows a representation of a portfolio of instruments arranged as a tree;

FIG. 7 shows one possible arrangement of data within a database in accordance with the present invention;

FIG. 8 shows another possible arrangement of data within a database in accordance with the present invention;

FIG. 9 shows a flowchart of a process for determining and storing values for instruments in a portfolio in accordance with the present invention;

FIG. 10 shows a block diagram of another embodiment of the present invention including three risk engines; and

FIG. 11 shows a cublet of multidimensional data, the amount of information included in the cublet in each dimension being selected such that the total size of the data in the cublet is less than or equal to a fixed maximum amount of data that can be read from a storage device.

### DETAILED DESCRIPTION OF THE INVENTION

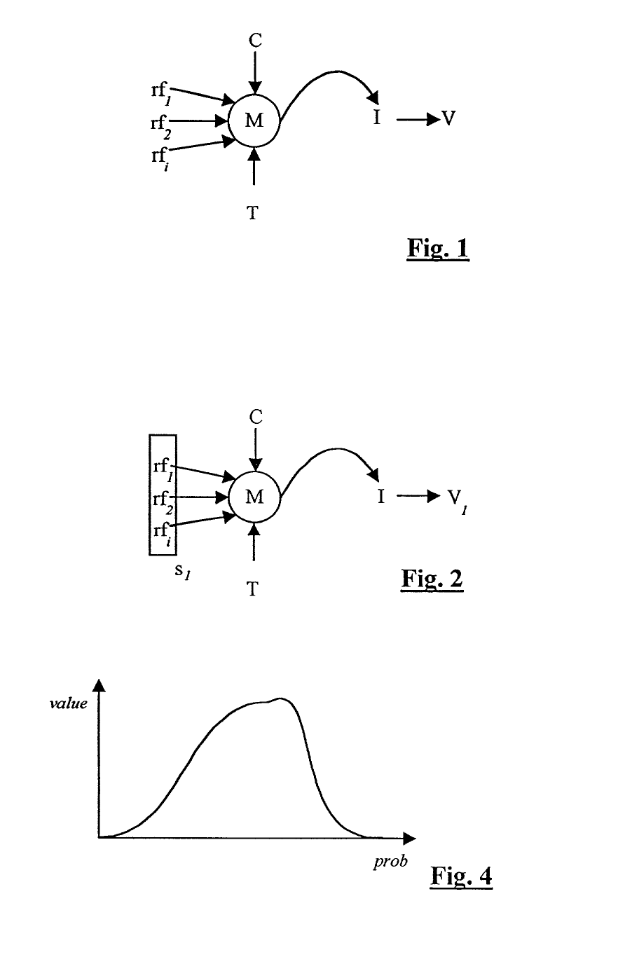

For clarity, before discussing the present invention in detail, a more detailed discussion of aspects of prior art risk management systems will be provided with reference to FIGS. 1 through 4. FIG. 1 shows a representation of a known mark to market function for an instrument I in a defined portfolio of instruments P. In the Figure, a model M has been created for the instrument I under consideration. Model M takes one or more risk factors rfᵢ as input and, generally, a time input T, which it then processes for instrument I to obtain a risk value V. In fact as used herein, the term risk value is intended to comprise any suitable measure of risk for the instrument. V can be the monetary value of the instrument or can be another derived risk value, such as a delta, gamma or sensitivity value, expressed in appropriate units. Further, V need not be a single value, as multiple values such as a delta and a gamma can be determined and stored if desired.

Model M also accepts a calibration value C, as necessary to calibrate the model to current conditions. Risk factors can comprise a variety of data, including interest rates or rate spreads, foreign exchange rates, etc. Further, instruments I are not limited to financial investment instruments and can include other instruments, including insurance instruments, commodity options, etc. While an instrument I will most commonly be a financial instrument such as a stock, bond, derivative product, insurance product etc., as will be discussed below in more detail with respect to credit loses, in the present invention an instrument is in fact any model which accepts one or more risk factors to simulate a characteristic of a real world entity including the likelihood of a default by a counter party, etc.

In order to accurately determine future risk values of an instrument, it is first necessary to determine the present risk value, or mark to market value, for the instrument and to calibrate the model M. In FIG. 1, risk factors rf₁ through rfᵢ are assigned their present actual (or best estimated) values, T is assigned a zero value (eg.—present time) and V is determined. A calibration value C is determined and applied to M to ensure correspondence of the determined value V and the actual risk value of I at the present. Calibration value C is stored for model M and is employed for all further calculations until the model is re-calibrated at a new time T=0.

Once all models M for all instruments I in portfolio P are calibrated and mark to market risk values are determined for each instrument I in portfolio P, the risk analysis can be performed for P by applying a set scenarios s and a time T to models M to obtain mark to future risk values for each instrument I. A scenario s comprises a vector with a value for each risk factor rfᵢ employed by a model M in portfolio P and each scenario has associated with it a probability of its likelihood of occurrence. FIG. 2 shows model M being evaluated at a selected time T under scenario s₁ to produce a value V₁, which is the risk value of instrument I at time T for the values of the risk factors defined in scenario S,.

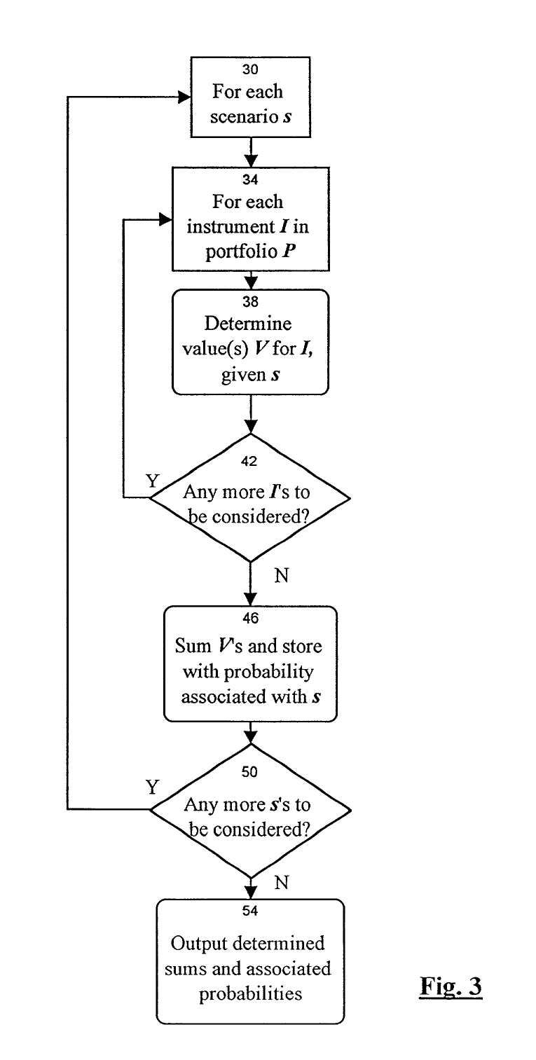

FIG. 3 shows a flowchart of the prior art process of producing a risk metric for a predefined portfolio P. At step 30, an outer loop for portfolio P is established to process each scenario s in turn. At step 34, an inner loop is established to process each instrument I in turn. At step 38, the risk value V of the present instrument I under consideration for the present scenario s is determined. At step 42 a determination is made as to whether any I's remain to be considered. If the condition is true, the process reverts to step 34 and the next I is selected and considered. If the condition is false, at step 46 the determined values for the I's are summed to get a total risk value for the portfolio which is stored, along with the probability assigned to scenario s. At step 50, a determination is made as to whether any scenarios s remain to be considered. If the condition is true, the process reverts to step 30 and the next scenario s is selected for consideration and steps 34 through 50 are performed again for the selected scenario s. If the condition is false, the process completes at step 54 by outputting the summed risk values and their associated probabilities. Often, this process will be performed at many different times T.

FIG. 4 shows a possible output of the process of FIG. 3, namely a distribution plot of portfolio P's monetary value under each scenario s versus the probability of each scenario s occurring. Such a distribution is then analyzed by the user to determine a variety of risk information such as Value at Risk (VaR), various forms of Regret or other risk metrics.

As mentioned above, additional risk information and/or a better understanding of the importance of various risk factors can be obtained by changing aspects of the scenarios and re-performing the method of FIG. 3.

Unfortunately, many portfolios of interest involve hundreds of instruments which are desired to be evaluated in view of hundreds of scenarios. Thus, performing the method of FIG. 3 can require significant amounts of computation time. Each time a re-performing of the analysis is desired, a similar amount of computation time is again required. This often serves to seriously limit the amount of analysis which can be performed. Further, as will be apparent to those of skill in the art, the resulting risk metrics for a portfolio cannot meaningfully be combined with a resulting risk metric for a second portfolio to obtain a risk metric for the combined portfolios. In other words, a determined risk metric for a portfolio P₁ can not be combined with a determined risk metric for a portfolio P₂ to obtain a risk metric for the portfolio P_{NEW} P₁+P₂. Instead, the portfolios must first be combined and the process of FIG. 3 then performed on the combined portfolio. Thus, in the context of an enterprise, determining risk at the local office level and at the enterprise level requires complete, independent, processing of each separate portfolio and each combined portfolio.

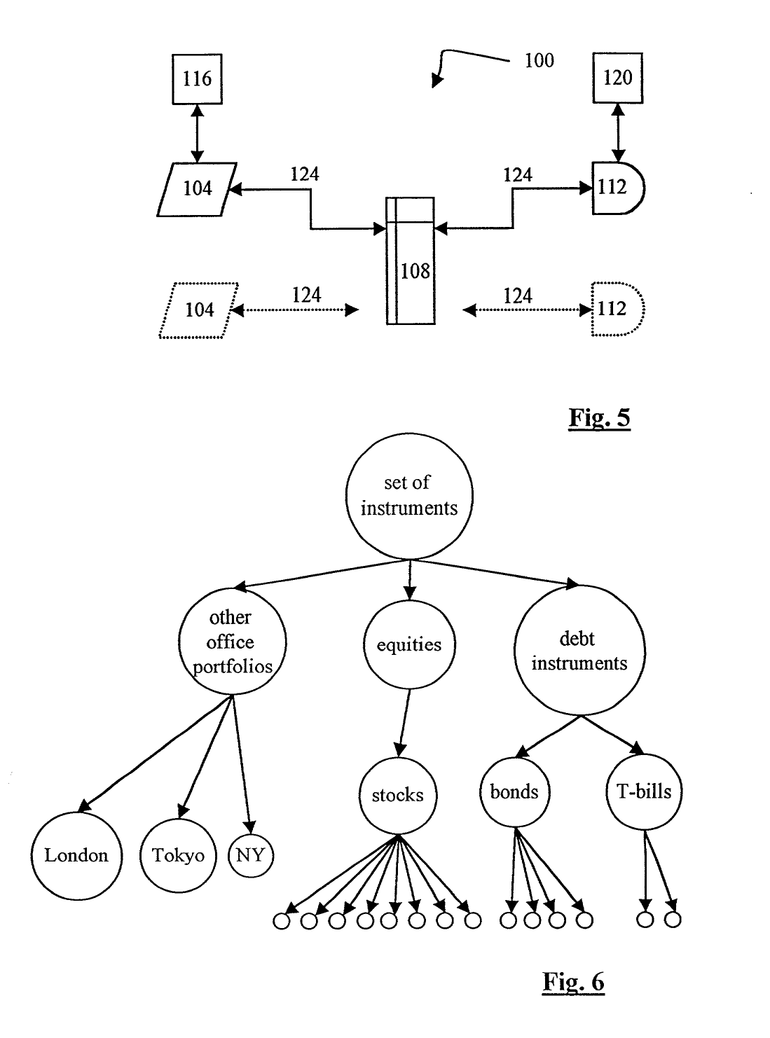

Embodiments of the present invention will now be described with reference to FIGS. 5 through 11. In FIG. 5, one embodiment of a risk system in accordance with the present invention is indicated generally at 100. Risk system 100 comprises at least one risk engine 104, a database 108 and at least one aggregation engine 112 and additional risk engines 104 and aggregation engines 112 are indicated in ghosted line. Each risk engine 104 can include a suitable user interface 116 to allow users to configure and operate risk engine 104 and each aggregation engine 112 can also include a suitable user interface 120 to allow users to configure and operate aggregation engine 112.

Risk engine 104 performs risk calculations for a set of instruments and processes the appropriate models and scenarios accordingly. Risk engine 104 is connected to database 108 by a suitable connection means, such as network 124. Scenarios and/or models for use by risk engine 104 in performing risk calculations can be stored locally within risk engine 104 but, in a presently preferred aspect of the present invention, are stored centrally in database 108 and provided to risk engines 104 as required. Aggregation engine 112 accesses database 108 through a suitable connection means, such as network 124, to retrieve stored risk values and other information, further process them and output desired results to a user.

In addition to models and/or scenarios, in the present invention database 108 stores instrument and/or aggregated risk values and related information. Specifically, it is possible to consider a portfolio as a tree of instruments, as shown in FIG. 6, with the leaf nodes representing the instruments, or other sets of instruments, and intermediate nodes representing various groupings and arrangements of the leaf nodes. Depending upon the degree of granularity desired in subsequent analysis, as described further below, database 108 can store values for each leaf node (such as for each of the eight stock instruments) or can store aggregated determined values for intermediate nodes (such as a sum of the determined values for the four bond and two T-Bill instrument leaf nodes as an aggregated total for “debt instruments”, along with and associated information) or can store values for aggregated sub-portfolios as leaf nodes, such as the illustrated New York, London and Tokyo subsets of instruments. Thus, as described below in more detail, the present invention determines risk values at an instrument level instead of at a portfolio level, as was the case with the prior art.

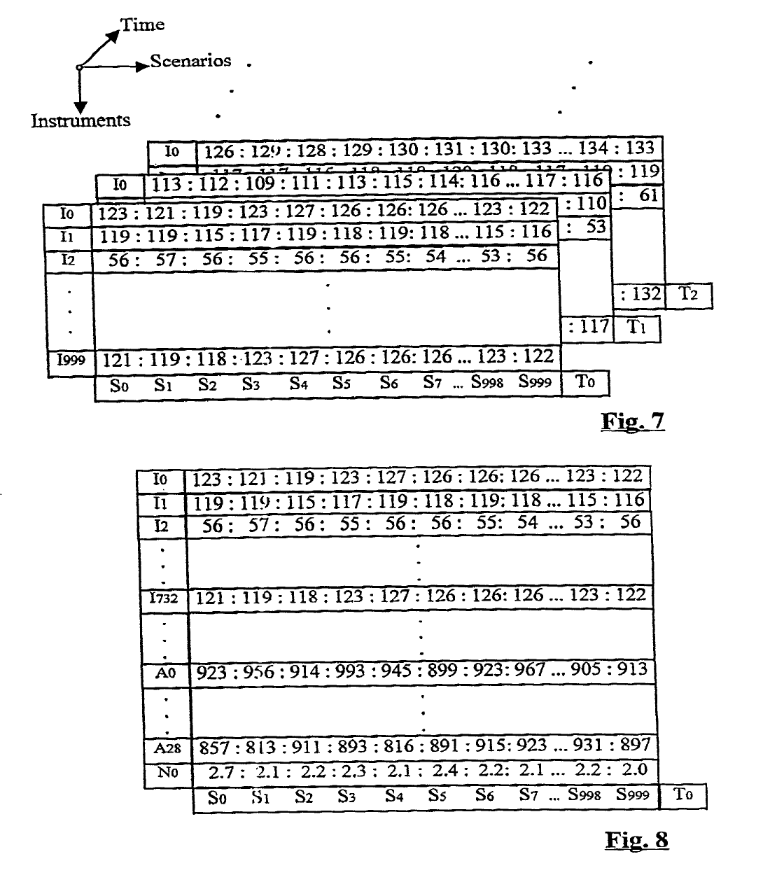

FIG. 7 shows a structure for database 108 in one embodiment of the present invention. As shown, database 108 is arranged as a multi-dimensional data structure with one axis (the vertical axis in the illustration) representing instruments, another axis (the horizontal axis in the illustration) representing scenarios and a third axis (the depth axis in the illustration) representing time. In the illustrated portion of database 108 shown in FIG. 7, leaf node information is stored and thus the determined value of each instrument (I₀ through I₉₉₉) under each scenario (S₀ through S₉₉₉) at each time of interest (T₀ through T₂) is stored within database 108. As mentioned above, aggregated information can also be stored, in the alternative, for some or all instruments or for subsets of instruments. Further, database 108 can store additional information relating to the instruments or subset of instruments. For example, FIG. 8 shows the contents of database 108 wherein determined leaf values are stored for instruments I₀ through I₇₃₂ and aggregated values are stored for groups A₀ through A₂₈ of other instruments. The actual definitions of which instruments are in which groups Aᵢ can be stored elsewhere in database 108.

As is also shown, database 108 can store additional useful related information. For example, vector N₀ can represent a British pound to US dollar foreign exchange rate used in the calculations of values in each respective scenario. It is also contemplated that the actual risk factors in each scenario be saved in database 108 as well. As discussed further below, storage of such additional information can be advantageous in the use of aggregation engine 112. Also, definitions of portfolios and sub-portfolios can be stored, to identify the instruments and quantities of the instruments in those portfolios. Finally, if desired, multiple values, such as deltas, gammas or other determined risk values can be stored within database 108 for each instrument, or aggregated group of instruments, under each scenario at each time.

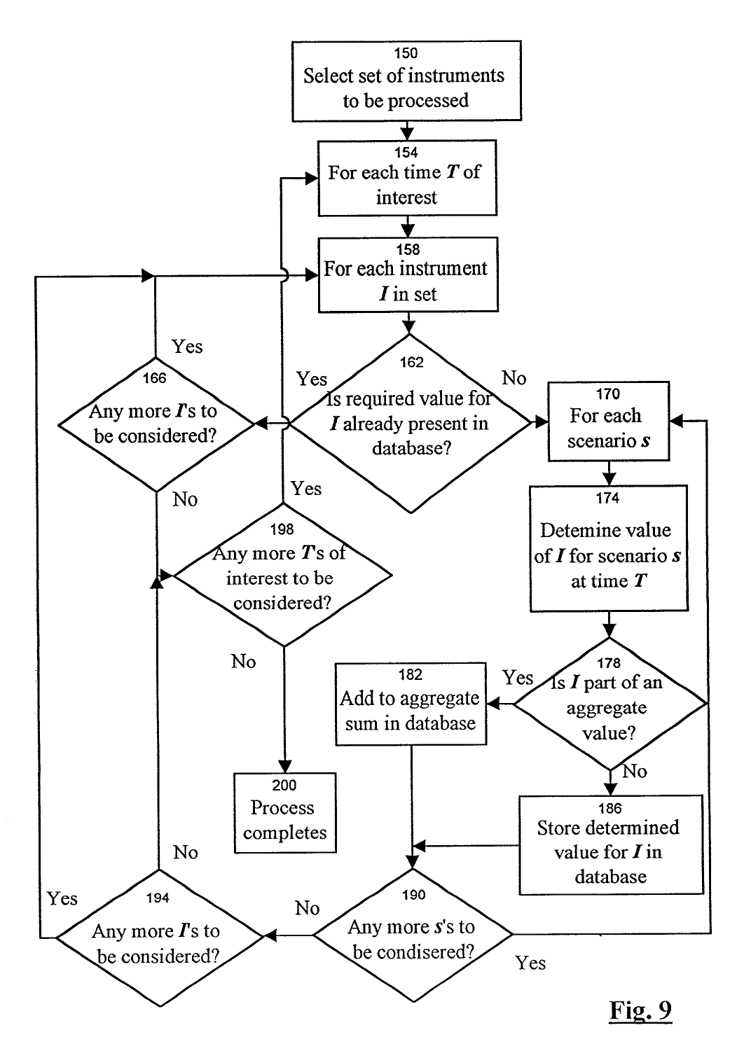

FIG. 9 shows a flowchart representing a process of determining values in accordance with the present invention. At step 150, a user instructs a risk engine 104 to process a selected set of instruments. Generally, this set will comprise a selection of all of the instruments and/or aggregated sets of instruments stored in database 108, although it is also contemplated that this set can comprise a subset of these instruments if desired. Such a subset can be explicitly specified by a user, or can be determined within the process on an appropriate basis, such as by selecting those instruments which have not been processed since a given time, or those instruments whose models have changed since they were last processed, etc.

The user also selects a time or times T at which risk values are to be determined and specifies a set of scenarios which the set of instruments is to be valued for. Again, these scenarios can be created and/or input by the user, but more commonly would be predefined and stored in database 108 for the set of instruments. Finally, the particular risk value or values (mark to future value, mark to future gamma, delta, etc.) to be determined are selected.

In the following discussion, for clarity and simplicity, it is assumed that only a single risk value is to be determined for each instrument stored in database 108. In any event, prior to commencing the process of FIG. 9, a user will specify which risk value or values is desired. At step 154, risk engine 104 takes the first time T of interest and, at step 158, selects a first instrument I in the set of instruments. In most circumstances, the first time T processed by the system will be T=0(i.e.—the present) and mark to market risk values and appropriate calibration values for models M are determined and stored in database 108. Subsequent iterations of the process can be performed at desired times T≠0 to obtain desired mark to future or other risk values, as described below.

At step 162, a check can be made to determine if the required risk value or values for I at time Tare already present in database 108. As described below in more detail, the present invention can allow multiple users using multiple risk engines 104 and aggregation engines 112 to interact with database 108 and/or information can be obtained from service bureaus or the like by subscription. Thus, step 162 can be performed to verify whether required risk values have previously been obtained or calculated and stored in database 108.

If the required risk value for instrument I is already present in database 108 for time T, a determination is made at step 166 as to whether additional I's remain to be considered. As will be apparent those of skill in the art, an analysis can have been performed for times T₁, T₂, and T₃, for example, but the present analysis may wish to consider times T₁, T₃, T₄ and T₅. In such a case, risk values need only be determined for times T₄ and T₅ as the risk values for the other times are already available in database 108.

If there are more I's to be considered, the process returns to step 158 where the next I is selected. If no more I's remain to be considered, at step 198 a determination is made as to whether any additional T's remain to be considered. If, at step 198, there are one or more T's to be considered, the process returns to step 154 where the next T of interest is selected. If no T's remain to be considered, the process completes at step 200.

If, at step 162, it is determined that the required values for I at time T are not present in database 108, then a first scenario s is selected at step 170 and the desired risk value for I at time T for scenario s is determined at step 174. At step 178 a determination is made as to whether the risk value for I is to be stored as part of an aggregated value or whether it is to be stored as a leaf value. If it is part of an aggregated value, the risk value of I is summed or otherwise appropriately combined with the value of the appropriate aggregate in database 108 at step 182. If it is not part of an aggregated value, the risk value for I is stored as a leaf value in database 108 at step 186. In either event, once the determined risk value has been appropriately stored, a determination is made at step 190 as to whether any more scenarios s remain to be considered. If scenarios do remain to be considered, the process returns to step 170 wherein the next scenario s of interest is selected. If no scenarios remain to be considered at step 190, a determination is then made at step 194 as to whether any I's remain to be considered in the selected set. If one or more I's do remain to be considered, the process returns to step 158 wherein the next I to be considered is selected. If no more I's remain to be considered, at step 198 a determination is made as to whether additional T's remain to be considered, as discussed above. When no more T's remain to be considered, the process completes at step 200.

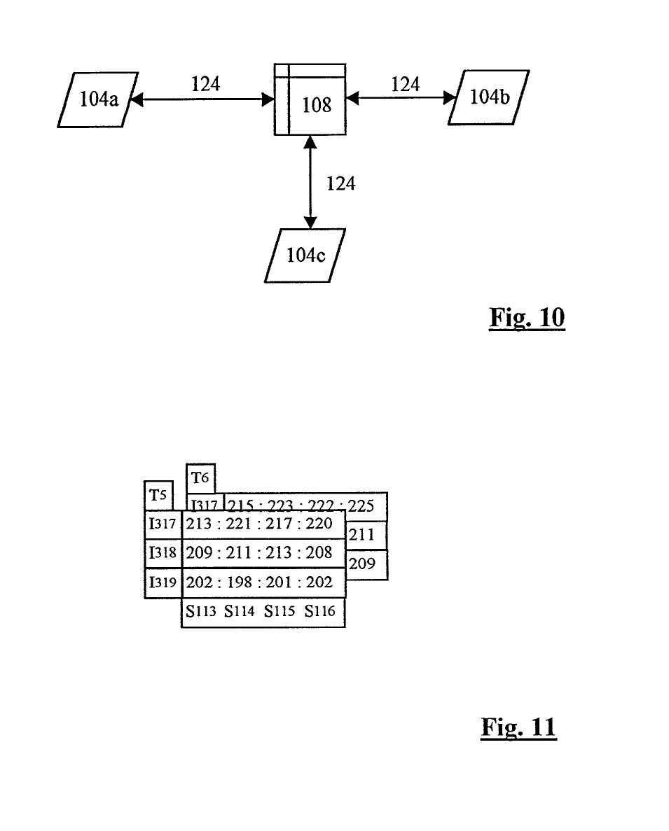

As will be apparent to those of skill in the art, the ordering of the loops in the process of FIG. 9 can be rearranged without departing from the spirit of the invention. For example, the process can be performed by looping through each scenario, to process each instrument in a selected set for each desired time, etc. As will also be apparent to those of skill in the art, the process of FIG. 9 can be performed in parallel on two or more risk engines 104 to decrease the time required to complete the process. For example, risk system 100 can include three risk engines 104a, 104b and 104c, as shown in FIG. 10. In such a case, each of risk engines 104a, 104b and 104c can process one third of the instruments in the selected set of instruments for each scenario s and time T, or can process a third of the scenarios s for each instrument in the selected set of instruments at each time T₁ etc. As will be apparent to those of skill in the art, it is generally required that a value for a first time T₂, be determined before a value for a later time T₂ is determined, thus parallelization of the process of FIG. 9 can only be advantageously performed on the basis of scenarios or instruments and not for time, as time calculations must be performed in a serial manner.

The selected set of instruments, referred to above, is not particularly limited. For example, this set can correspond to a single portfolio P, two or more portfolios P₁, P₂, or even subsets of a single portfolio P. Further, additional instruments, not yet in a portfolio or portfolios, can be specified as being of interest, for example as being possible candidates for inclusion in a portfolio, and the process performed on these instruments as well. It is contemplated that, in many circumstances, the selected set of instruments will correspond to all of the instruments stored in database 108.

It is also contemplated that some information in database 108 can be provided by a service bureau. For example, vectors of values (such as row I₀ in FIG. 8) for common financial instruments such as government bonds can be provided for standard agreed sets of scenarios and models on a subscription basis. This information can be loaded into database 108 at appropriate times and thus, the process of FIG. 9 need only calculate values for those instruments I which are unusual or which are otherwise not available from such a service bureau.

Referring again to FIG. 5, aggregation engines 112 employ the information of database 108 to present a variety of information and analysis to a user. For example, to create a distribution, such as that shown in FIG. 4, for a portfolio P, a user can specify the desired portfolio P and the risk metrics desired through user interface 120. The instruments and their quantities in the portfolio P can have been predefined and stored in database 108, or elsewhere, or can be specified on an ad-hoc basis by the user. Aggregation engine 112 then recalls the risk information appropriate to portfolio P from database 108 and presents the desired information for output to the user.

If some information required by aggregation engine 112 is not available in database 108, aggregation engine 112 can be configured to indicate the missing information to the user and/or to start a risk engine 104 with the missing information specified as the set of instruments, times and scenarios of interest on which the process of FIG. 9 is to be performed.

Depending upon the desired information and the particular portfolio P, the information retrieved by aggregation engine 112 from database 108 can be leaf node values or aggregated values or a combination of both. Also, depending upon the portfolio P and/or the desired information, aggregation engine 112 can retrieve additional stored information such as foreign exchange rates, interest rates or other risk factors applicable to the scenarios of interest. This additional information can be employed by aggregation engine 112 in a variety of ways, including combining instruments I of different underlying currencies by converting them at the appropriate foreign exchange rate for each scenario, at each time, etc.

It is also contemplated that selected results of interest, produced by aggregation engine 112, can also be stored in database 108 as additional information. An example of the storage of such additional information and its use is discussed below, with reference to credit exposure risk and credit loss risk.

A risk system in accordance with the present invention, such as risk system 100, provides a number of advantages over prior art systems. First, as mentioned above, multiple risk engines 104 can be employed, in parallel, to process instruments, times, scenarios and models to obtain risk information in a time effective manner. Also, as leaf level information can be maintained in database 108, it is possible to define portfolios in an ad-hoc manner, or to alter the make up of a portfolio (i.e.—the particular instruments and their quantities in the portfolio) without requiring the recalculation of the entire portfolio. For example, a portfolio P can be examined with an aggregation engine 112. Depending upon the results, the user might wish to examine the difference in the overall risk if the makeup of portfolio P is changed by, for example, replacing short term government bond instruments in the portfolio with short term corporate bond instruments. With the present invention, a modified portfolio P′ can be created by copying the definition of portfolio P and substituting the appropriate instruments. Aggregation engine 112 can then retrieve the corresponding information from database 108 to provide the desired risk information. If some of the required information is not available in database 108, aggregation engine 112 can have a risk engine 104 calculate the unavailable information with the process of FIG. 9 and then recall the now calculated and stored values from database 108.

As information is stored in database 108, risk can be analyzed for a variety of portfolios comprising instruments stored in database 108. For example, a large financial trading institution can have trading operations New York, London and Tokyo. Portfolios P_{NY}, P_{LDN} and P_{TK} can be defined for the instruments held in each respective one of these offices. Each respective office can examine and manage its risk using its corresponding portfolio with system 100. The total risk for the financial institution can be examined and managed by the head office of the institution with an enterprise portfolio P_{E}, where P_{E}=P_{NY}+P_{LDN}+P_{TK}.

In such a case, a risk engine 104 can be run by at least one office or the head office to determine necessary risk values for the instruments in database 108. Each individual office can then run aggregation engine 112 as desired and, as described above, if risk values for one or more instruments are not stored and are needed for a particular portfolio, a risk engine 104 can be initiated by aggregation engine 112 to determine the needed values. The head office can analyze the risk to the enterprise by running aggregation engine 112 for portfolio P_{E}, retrieving all necessary values for the instruments of P_{E} from database 108 which have been determined and stored previously and a risk engine 104 can be initiated by aggregation engine 112 to determine the any missing values with the process of FIG. 9. Of course, P_{E} can also include additional instruments held by the enterprise and, in such a case, the aggregation engine 112 will initiate a risk engine 104 to determine those missing values with the process of FIG. 9.

Further, as mentioned above, it is often desired to determine the marginal risk of a proposed transaction to a portfolio. Also, it may be desired to determine the marginal risk at various levels of an enterprise, for example at a local level, a regional or country level and an global level. As database 108 can contain risk values for instruments in portfolios at all levels of an enterprise, marginal risk metrics, such as the Marginal Value at Risk (MVaR), can easily be determined. In fact, in many cases the desired risk values for all instruments of the portfolio of interest, including the desired risk values for the instrument of the proposed transaction, will already be present in database 108. Thus, a marginal risk metric for any portfolio can be determined merely by having an aggregation engine 112 aggregate the stored values for the instruments in the portfolio and does not require the recalculation of the entire portfolio, unlike prior art risk management systems. If the appropriate risk values of the instrument of the proposed transaction are not stored, they can be computed by a risk engine 104 and stored in database 108 and then accessed by an aggregation engine 112, as before.

Similarly, the present invention allows for improved risk management at an enterprise level and risk capital can be allocated, for example, amongst competing business units in a financial institution, without requiring the recalculation of the entire portfolios. Under most financial regulatory regimes, taking risk requires capital to be allocated against that risk. However, the amount of capital available to a financial institution is limited and thus the allocation of available capital to business units should be performed in an attempt to maximize the revenue from that capital. In such a circumstance, the present invention can allow each business unit to understand its use of enterprise risk capital on a marginal basis. Providing each unit with measures of risk-adjusted returns, on a marginal basis, allows enterprise-efficient decisions to be made by each business unit.

In addition, “what-if” analysis can be more performed more effectively, to determine sensitivities, etc. If, after reviewing a risk metric produced by aggregation engine 112, it is desired to determine the difference that the “flattening-out” of a risk factor will make on a portfolio, the portfolio can be processed again accordingly. In such a circumstance, the process discussed above with respect to FIG. 9 is performed with the additional step of checking each instrument prior to recalculating its value to determine if the underlying model for the instrument is dependent upon the changed risk factor. Only those instruments whose values are dependent upon the changed risk factor are re-processed. Aggregation engine 112 can then output new risk metrics indicating the result of the flattening-out operations. It is also contemplated that such what-if results can be stored separately from the other results in database 108 so that the original results are always available, even while what-if and other analysis is being performed. These what-if results can be removed from database 108, once they are no longer required, or overwritten with subsequent what-if results to reduce the total storage requirements of database 108.

Another advantage of the present invention is its ability to determine risk metrics for other aspects of a portfolio. For example, the present invention can be employed to determine a credit exposure risk. Specifically, a futures transaction between an institution and a counter party results in a credit exposure to the institution anytime the counter party is “out of the money”, i.e.—the counter party owes the institution money. As being in or out of the money depends solely on market conditions at the time under consideration, the total credit exposure of the institution changes with scenarios and/or times. With the present invention, aggregation engine 112 can aggregate values of portfolios, on a counter party basis, for each scenario and time period of interest to determine the risk associated with the credit exposure of the institution to the counter party. These the determined exposures can be stored in database 108 by aggregation engine 112. Storage of such additional information as credit exposures allows the present invention to determine associated risk information, such as credit loss risk. In the case, an aggregation engine 112 can recall the determined exposures from database 108 and aggregate these values to determine the credit loss

If desired, the present invention can also determine credit loss risk. Specifically, a model representing whether a counter party would default and the relative amount of that default (i.e.—30% would be recovered of the total amount outstanding) for counter parties can be stored in database 108 and processed by a risk engine 104 to obtain corresponding risk values. Aggregation engine 112 can then aggregate these default values with the credit exposure values, discussed above, to obtain a credit loss risk metric.

As will be apparent to those of skill in the art, in addition to permitting multiple risk engines 104, the present invention also permits multiple aggregation engines 112 to be employed. Thus, in the above-mentioned enterprise risk situation for example, each individual office can include one or more risk engines 104 and one or more aggregation engines 112, each of which communicates with database 108 as needed.

As will also be apparent to those of skill in the art, database 108 need not be a single database. In fact, due to the large amount of information which can be required to be stored in database 108, it is contemplated that in many circumstances database 108 will comprise two or more sub-databases which can be distributed in any appropriate manner. For example, results for scenarios zero through forty-nine can be stored in one sub-database and results for scenarios fifty through ninety-nine can be stored in another sub-database, database 108 comprising these two sub-databases. It is further contemplated that risk values for each instrument for each scenario and time of interest can be stored in one or more sub-databases while the underlying instrument definitions and models, scenarios, risk values and other information of interest can be stored in one or more other sub-databases. It is also contemplated that portions of database 108 can be replicated in various diverse locations for efficiency. For example, the portion of database 108 representing values for the P_{TK} portfolio, mentioned above, can be replicated in Tokyo in addition to being stored in a complete enterprise database 108 at the financial institution's head office.

Database 108 can include a great deal of information, on the order of terabytes or more. Accordingly, it is important to have an efficient means of storing and retrieving this information. One efficiency is mentioned briefly above, in that database 108 can be implemented as a set of distributed sub-databases. Another aspect of the present invention developed by the present inventors to improve efficiency is a multidimensional data writing technique. As is known, most storage devices have a optimum amount of information that can be transferred in a single operation. For example, a Winchester-style disk drive typically can read several track sectors or even an entire disk track in a single operation, this amount of information being referred to herein as a disk page. Generally, reading less than a disk page requires the same amount of time as reading the entire disk page and thus disk page-sized operations tend to be most efficient.

In the multi-dimensional writing technique in accordance with the present invention, the data in database 108 is arranged in multidimensional groupings referred to a “cublets”. Each cublet comprises a data structure including adjacent data in each of the three dimensions of database 108. For example, as shown in FIG. 11, a cublet can include three adjacent instruments (I₃₁₇, I₃₁₈ and I₃₁₉) and their values under four adjacent scenarios (s₁₁₃, s₁₁₄, s₁₁₅ and s₁₁₆) for two times (T₅ and T₆). The size of the total amount of data stored in a cublet is selected to be as close as possible to the size of a disk page, without exceeding that size, and cublets are written to the disk or disks of database 108 as disk pages. In this manner, any data retrieval operation will obtain a set of adjacent information in each dimension, allowing efficient retrieval of information from database 108.

While the total size of the data in each cublet is essentially fixed by the size of the disk page, the make up of a cublet can be varied appropriately. Specifically, the amount of adjacent data included in each dimension can be selected as appropriate. For example, for constructing a distribution such as that shown in FIG. 4, determined values at a single time T are required by aggregation engine 112. If such an analysis is typically performed more than other analysis which require values at different times, then database 108 can be written with cublets that have few time dimension entries and many scenario dimension entries It is contemplated that a set of disk activity monitoring tools can be run on database 108 from time to time to determine information access patterns. Depending upon the patterns obtained, database 108 can be re-written with cublets having different dimensional sizes (eg.—more time entries and fewer instrument entries, etc.) to improve efficiency according to how the data is most often used by aggregation engine 112.

The present invention provides significant advantages over prior art risk management systems. The present invention allows risk calculations to be performed in parallel, allows multiple risk engines and/or aggregation engines to simultaneously operate on risk data and allows what-if and other types of analysis to be performed quickly and efficiently. Portfolio make up can be changed and risk metrics obtained in an iterative fashion, if desired. Marginal risk metrics can be determined, without requiring recalculation of an entire portfolio and credit exposure and credit loss risk metrics can be obtained.

The above-described embodiments of the invention are intended to be examples of the present invention and alterations and modifications may be effected thereto, by those of skill in the art, without departing from the scope of the invention which is defined solely by the claims appended hereto.

We claim:

1. A method of determining at least one risk metric for a portfolio of instruments, comprising the steps of:
(i) selecting a set of instruments, each instrument in said set having a model defined therefore, each model operating on at least one risk factor to produce a value for said instrument;
(ii) selecting a set of scenarios, each scenario comprising a risk factor value for each risk factor operated on by said models of said instruments at at least a first and second time interval and each scenario having a probability value assigned thereto, said probability value representing the likelihood of said scenario occurring;
(iii) applying said selected set of scenarios to said set of instruments to produce a risk value for each instrument in said set of instruments for each scenario in said set of scenarios for each time interval;
(iv) storing in a database each instrument risk value produced for each instrument in said set; and
(v) for a portfolio of instruments comprising at least a subset of said set of instruments, producing a desired risk metric from said associated probabilities and said determined risk values for each instrument of said portfolio by retrieving said stored risk values from said database.

2. The method of claim 1 comprising the step of defining whether each instrument value produced is stored in step (iv) as an individual instrument value or is aggregated with at least one other instrument value and stored as an aggregated value.

3. The method of claim 1 where in step (v), said user first selects a subset of instruments of interest from said set of instruments and said desired risk metric is produced for said subset by retrieving determined risk values for each instrument in said subset from said database.

4. The method of claim 1 wherein said risk factor values for each said risk factor are also stored in said database.

5. The method of claim 1 wherein definitions of portfolios of instruments stored in said database are predefined.

6. The method of claim 5 wherein said definitions of portfolios are stored in said database.

7. The method of claim 1 where in step (iii), a check is first performed to determine if corresponding risk values for an instrument are already present in said database and risk values are only produced for those not already present.

8. The method of claim 1 where steps (iii) and (iv) are performed in parallel on subsets of said set of instruments.

9. The method of claim 1 where step (v) is performed by at least two users, each of said at least two users producing a risk metric for a different selected subset of said set of instruments.

10. The method of claim 9 where step (v) is performed in parallel by each of said at least two users.

11. The method of claim 1 wherein said database is organized as a multi-dimensional structure, one axis of said structure representing instruments, another axis of said structure representing scenarios and another axis of said structure representing time.

12. The method of claim 11 wherein data is read from and written to said database in multidimensional groupings, wherein said grouping includes a selected amount of adjacent data from each of said axes of said structure.

13. The method of claim 12 wherein said selected amount of adjacent data on a first axis differs from said selected amount of data on a second axis.

14. The method of claim 12 wherein the total size of storage required for said multi-dimensional groupings does not exceed a preselected size.

15. The method of claim 1 further comprising the step of modifying said set of scenarios to change at least one risk factor value and performing steps (iii) through (v) to produce a new risk metric.

16. The method of claim 15 wherein said at least one risk factor value is changed such that said value does not change with time.

17. The method of claim 7 further comprising the step of selecting a first subset of said set of instruments and determining a risk metric and selecting a second subset of said instruments wherein at least one instrument in said first subset is replaced with another instrument, and performing steps (iii) through (v) to produce a new risk metric.

18. The method of claim 1 wherein step (v) further comprises the step of storing said produced risk metrics in said database.

19. The method of claim 1 further comprising the step of determining a credit exposure risk for at least one first party who is counter party for at least one of said instruments in said set of instruments, further comprising the step of:
(vi) determining a subset of said set of instruments for which said first party is the counter party and determining the credit exposure for said first party by retrieving said stored values and said associated probabilities from said database.

20. A risk management system operable on set of instruments and a set of scenarios, each scenario including risk factor values and a scenario probability, said system comprising:
at least one risk engine operable to determine a risk value for each instrument in said set of instruments, said risk value determined by evaluating, in view of said risk factors in said scenario, a model stored for said instrument;
a database to store each said determined risk value; and
an aggregating engine to retrieve said determined risk values and said scenario probabilities for a portfolio comprising at least a subset of said set of instruments to produce a risk metric.

21. A risk management system according to claim 20 wherein said risk engine further comprises a user interface to allow a user to define a portfolio of instruments for said aggregating engine to operate on.

22. A risk management system according to claim 21 wherein defined portfolios are stored in said database.

23. A risk management system according to claim 20 comprising at least two risk engines, each of said at least two risk engines operating in parallel to produce instrument values for a subset of said set of instruments.

24. A method of determining the marginal risk in at least one risk metric for a portfolio, comprising a set of instruments, which would result from a proposed transaction to alter said portfolio, each instrument in said portfolio and each instrument in said proposed transaction having a model defined therefore, each model operating on at least one risk factor to produce a value for said instrument, the method comprising the steps of:
(i) selecting a set of scenarios, each scenario comprising a risk factor value for each risk factor operated on by said models of said instruments at at least a first and second time interval and each scenario having a probability value assigned thereto, said probability value representing the likelihood of said scenario occurring;
(ii) applying said selected set of scenarios to said portfolio to produce a first risk value for each instrument in said portfolio for each scenario in said set of scenarios for each time interval;
(iii) storing in a database each first risk value produced for each instrument in said portfolio;
(iv) producing a first measure of said at least one risk metric from said associated probabilities and said determined first risk values for each instrument of said portfolio by retrieving said stored first risk values from said database;
(v) for each instrument in said set of instruments affected by said proposed transaction, altering each said affected instrument in accordance with said propose transaction and applying said selected set of scenarios to each altered instrument to produce a second risk value for each altered instrument for each scenario in said set of scenarios for each time interval; and
(vi) producing a second measure of said at least one risk metric by combining associated probabilities and said second risk values for said altered instruments with said first stored risk values for unaltered instruments in said set of instruments retrieved from said database to produce a second measure of said at least one risk metric.

25. The method of claim 24 wherein said second risk values are stored in said database.

26. The method of claim 24 wherein said proposed transaction comprises altering the amount of at least one instrument in said set of instruments.

27. The method of claim 24 wherein said proposed transaction comprises adding an instrument to said set of instruments.

28. The method of claim 24 wherein steps (v) and (vi) are performed for a second proposed transaction and said second measure of said at least one risk metric is produced for each of said proposed transactions.

29. A method of determining counter party credit exposure risk for a portfolio comprising a set of instruments, comprising the steps of:
(i) selecting a set of scenarios, each scenario comprising a risk factor value for each risk factor operated on by said models of said instruments at at least a first and second time interval and each scenario having a probability value assigned thereto, said probability value representing the likelihood of said scenario occurring;
(ii) applying said selected set of scenarios to said portfolio to produce a value for each instrument in said portfolio for each scenario in said set of scenarios for each time interval;
(iii) storing in a database each value produced for each instrument in said portfolio; and
(iv) determining a subset of said set of instruments for which a first party of interest is the counter party and determining the credit exposure for said first party of interest by retrieving said stored values and said associated probabilities from said database.
